(19) United States
(12) Patent Application Publication
(10) Pub. No.: US 2010/0255692 A1
(43) Pub. Date: Oct. 7, 2010

(54) ELECTRICAL CONNECTION SYSTEM

(75) Inventors: Melitta Bott, Hollstadt (DE); Bernhard Knüttel, Bad Neustadt a. d. Saale (DE)

Correspondence Address: CANTOR COLBURN, LLP, 20 Church Street, 22nd Floor, Hartford, CT, 06103, US

(73) Assignee: PREH GMBH, Bad Neustadt a. d. Saale (DE)

(21) Appl. No.: 12/740,609

(22) PCT Filed: Oct. 30, 2008
(86) PCT No.: PCT/EP08/09168

§ 371 Date: Apr. 29, 2010

(30) Foreign Application Priority Data
Oct. 30, 2007 (DE) 10 2007 052 210.1

(51) Int. Cl. H01R 12/18

(52) U.S. Cl. 439/76.1

(57) ABSTRACT

The invention relates to an electrical connection system (1) comprising a housing (12), into which electrical and/or mechanical components may be integrated, at least one printed circuit board (30) that can be positioned on the housing (12), having at least one printed circuit board connection (34, 36) and at least one contact element (18, 20) that is held on the housing (12) in a stationary manner, said contact element having a contacting section (22, 24) on the free end thereof for electrically contacting the printed circuit board connection (34, 36), wherein the contact element (18, 20) is configured in a bendable manner at least in regions such that the contacting section (22, 24) can be bent from an assembly position, in which said contacting section is not in contact with the printed circuit board connection (34, 36), into a contacting position, in which said contacting section is electric contact with the printed circuit board connection (34, 36).

### CROSS-REFERENCE TO RELATED APPLICATIONS

This patent application claims priority to German Patent Application No. DE 10 2007 052 210.1, filed Jul. 30, 2007 which is hereby expressly incorporated by reference in its entirety.

### TECHNICAL FIELD

The present invention relates to electrical connection system.

The invention relates to an electrical connection system comprising a housing into which electrical and/or mechanical components can be integrated, at least one circuit board which can be positioned on the housing and comprises at least one circuit board connector for electrical contacting, and at least one contact element for the electrical contacting of the circuit board connector, said contact element being held firmly on the housing.

### BACKGROUND

Electrical connection systems of the type mentioned above are known in the prior art in various designs.

DE 39 28 751 C2, for example, describes an electrical connection system in the form of an electrical connection box for the wiring of motor vehicles. The connection box comprises a top and a bottom housing part which can be assembled to form an integral housing. A circuit board comprising several conductor webs, each of which comprise circuit board connectors for electrical contacting in the form of web strips disposed perpendicularly to the circuit board, is accommodated in the housing. Contact elements are provided for the electrical contacting of these circuit board connectors. Said contact elements each comprise a base part, at least one contact portion formed on the base part, and a clamping portion which is formed integrally with the base part and is in frictional engagement with a contact element. Each clamping portion comprises two protruding legs, the free ends of which are formed into clamping projections, so that a web strip of a conductor web can be accommodated between these two legs in a resilient manner by friction fit. One drawback of this electrical connection system lies in the fact that the contact elements always grip around the circuit board connectors from above, which is why the contact elements and the circuit board must be arranged one above the other. Accordingly, the freedom in designing the electrical connection system is limited to a large extent.

### BRIEF SUMMARY

The disclosure provides an electrical connection system of the type mentioned in the introduction which ensures a secure and rugged electrical contacting while enabling comfortable handling, and in which the contact elements and the circuit board can optionally also be arranged next to each other.

According to the invention, this is achieved by the contact element being formed in a flexible manner, so that the contacting portion can be moved from an assembly position, in which it is not in electrical contact with the circuit board connector, into a contacting position, in which it is in electrical contact with the circuit board connector. Because of the flexible design of its contacting end, the contact element, following the arrangement of the circuit board on the housing, only needs to be transferred from the assembly position into the contacting position in order to electrically connect the contact element with the circuit board. Thus, electrical contacting can be carried out simply and comfortably. In addition, in contrast to the prior art, the contact element and the circuit board connector inside the housing need not be disposed one above the other due to the configuration according to the invention, but can also be positioned next to each other, whereby a large degree of freedom is designing the electrical connection system is achieved.

The housing is preferably produced from plastic or insulated in light metal, in particular as an injection-molded article, in order to reduce its own weight.

According to an embodiment of the invention, the at least one contact element is embedded into the housing, and in particular into the bottom of the housing. Such an embedding eliminates one assembly step when the electrical connection system is put together.

For positioning the circuit board on the housing, the housing preferably has an opening into which the circuit board can at least partially be inserted from the outside, in particular pushed in. The position of the opening can be selected freely in the design of the electrical connection system according to the invention. Thus, it can, for example, be formed in the bottom of the housing.

Preferably, the circuit board connector has a recess open towards an end face of the circuit board, into which the contacting portion of the contact element engages in its contacting position. In that case, the contact element is bent from its assembly position into the contacting position in such a way that it is introduced into the recess of the circuit board connector. In order to realize the recess open towards the end face of the circuit board, the circuit board connector is preferably configured U-shaped.

In this embodiment, the contacting portion of the contact element is expediently configured H- or C-shaped, with the connecting web being insertable into the frontally open recess of the circuit board connector. In this case, the dimensions of the connecting web correspond to the dimensions of the recesses preferably such that a secure and rugged electrical contacting is ensured.

Expediently, the contact elements are in this case configured such that their parallel retaining webs come to rest on the main surfaces, i.e. the top and the bottom sides, of the circuit board when the connecting web is inserted into the recess of the circuit board connector and is held therein, in particular by friction fit. A detachable electrical contacting can be produced in this way, so that the circuit board can be removed and repaired or replaced with a new circuit board.

Alternatively or additionally, the free contacting end of the contact element can also be soldered, in the contacting position, to the circuit board connector or glued to it using an electrically conductive adhesive.

### BRIEF DESCRIPTION OF THE DRAWINGS

With regard to other advantageous embodiments of the invention, reference is made to the dependent claims as well as to the following description of an exemplary embodiment with reference to the attached drawing. In the drawings:

FIG. 1 shows a perspective view of an electrical connection system according to a preferred embodiment of the present invention;

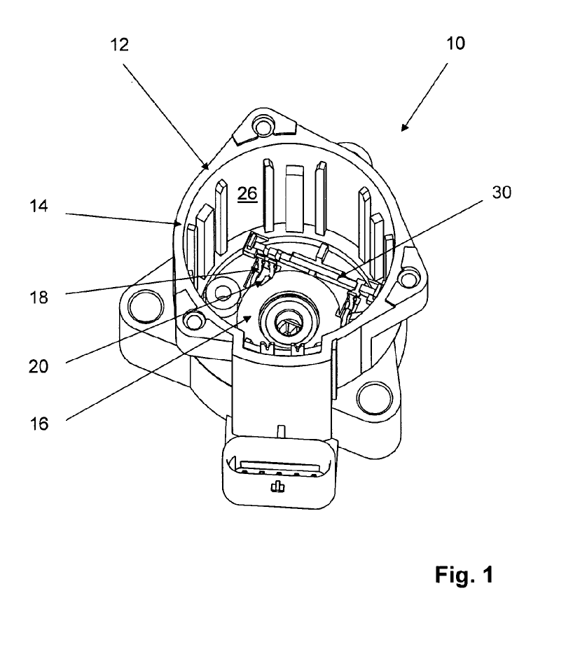

FIG. 2 shows an enlarged view of the detail designated in FIG. 1 with the reference numeral II;

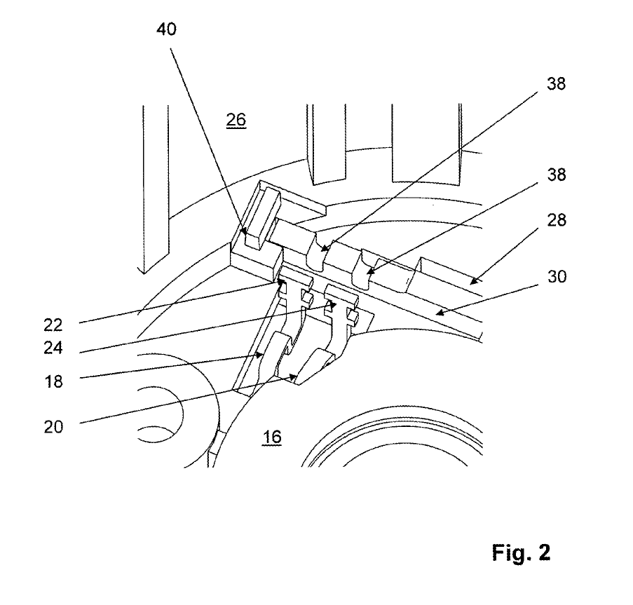

FIG. 3 shows a perspective view corresponding to FIG. 2 with a mounted circuit board, wherein the contacting portions of contact element of the connection system are in an assembly position;

FIG. 4 shows a view corresponding to FIG. 3, wherein the contacting portions of the contact element are in a contacting position;

FIG. 5 shows a perspective enlarged partial view of the portion of the circuit board comprising circuit board connectors; and

FIG. 6 shows a perspective view of the portion shown in FIG. 5 which shows the engagement between the contacting portions of the contact elements and the circuit board connector.

### DETAILED DESCRIPTION

An electrical connection system according to an embodiment of the present invention is shown in the drawing.

The electrical connection system 10 comprises a housing 12 with a housing wall 14, which substantially has the shape of a hollow cylinder, and a housing bottom 16 formed in one piece with the housing wall 14. Contact elements 18, 20 bearing contacting portions 22 and 24 protrude into the interior 26 of the housing. The contacting portions 22 and 24 are substantially configured in a H-shape. They each comprise two retaining webs 25a and 25b, which extend parallel relative to each other, and a connecting web 25c which extends transversally relative thereto.

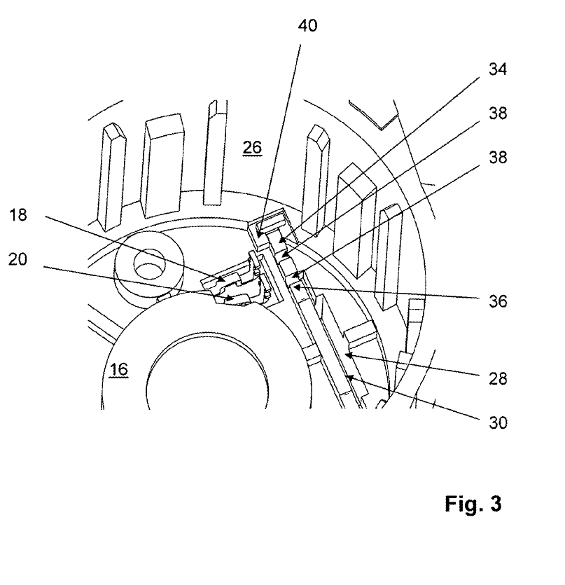

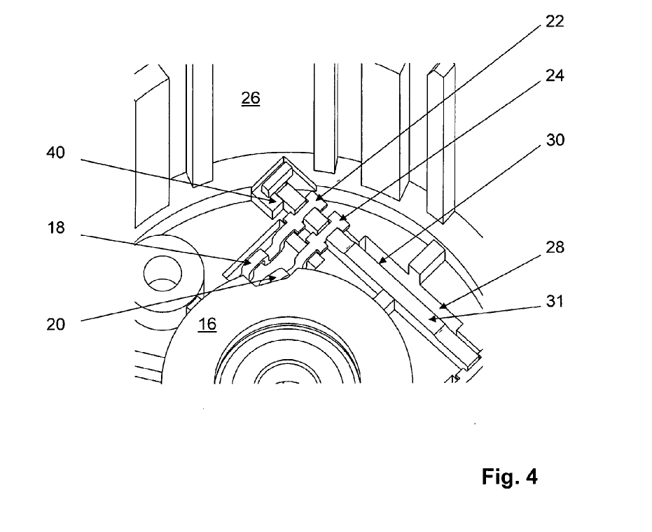

An opening 28 is formed in the bottom 16 of the housing into which a circuit board 30 of the connection system 10 is pushed in such a way that the circuit board 30 is retained in a positive fit and protrudes slightly into the interior 26 of the housing, as can be seen, in particular, in FIGS. 3 and 4. The circuit board 30 is additionally retained in pockets 40 of the housing 12, so that the circuit board 30 of the housing 12 seals towards the outside. Two circuit board connectors 34 and 26 for electrical contacting are provided at the top end face 31 of the circuit board protruding into the interior 26 of the housing. The circuit board connectors 34 and 36 are configured in a U-shape or in a rectangular shape and are inserted into corresponding recesses in the end face 31 of the circuit board such that they each define a recess 38 open towards the end face 31.

If an electrical connection between the contact elements 18, 20 and the circuit board 30 is to be established, the contact elements 18, 20 are bent towards the end face 31 of the circuit board in such a way that the connecting webs 25c of its contacting portions 22 and 24 engage into the recesses 38 of the circuit board connectors 34 and 36 provided on the end face 31 of the circuit board, so that an electrical contacting is effected. In the process, the retaining webs 25a and 25b are placed against the main surface of the circuit board 30, preferably creating a friction fit, whereby the contacting portions 22 and 24 are fixed on the circuit board 30. A detachable connection is produced in this manner, which is advantageous in that the circuit board 30 can be removed at all times for repair purposes or in order to be replaced. Of course, the contacting portions 22 and 24 can also be soldered to the circuit board connectors 34 and 36, or glued to them using a conductive adhesive.

If the circuit board 30 is now pushed into the opening, the ends of the contacts 22, 24 can be bent so that the circuit board 30 is electrically contacted. No limitation to the number of contacts is required in this case, rather, any number of contacts can be achieved. For this purpose, the circuit board 30 comprises connectors 34, 36 for electrical contacting with the ends of the contacts 22, 24.

Due to the structure of the contacting with the circuit board 30 according to the invention, it is now possible to contact the circuit board electrically securely with the contacts 22, 24, to secure the circuit board 30 in the housing 12, and furthermore, to ensure a secure electrical contacting. It is a substantial advantage of the invention that the circuit board 30 can be mounted in the direction of the cylindrical configuration of the housing 12, that is, the circuit board does not have to be aligned in a plane or parallel way relative to a lower end 16 of the housing 12, as in the conventional electrical assemblies, such as switches, operating elements, sensors or control devices, but can be mounted offset by 90° relative to the bottom 16 of the housing 12 in the direction of the cylindrical configuration of the housing 12.

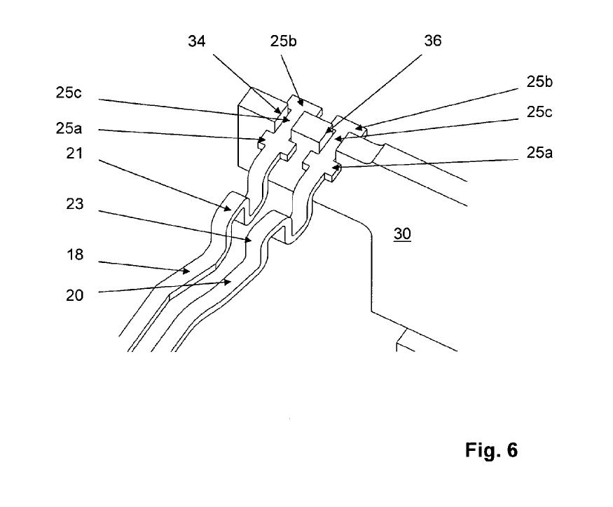

Compensating loops 21, 23, which are incorporated into the contact elements 18, 20 in a meandering shape in front of the contacting portions 22, 24, are incorporated into the contact elements 18, 20, as is shown particularly clearly in FIG. 6. Due to the meander-shaped configuration of the contact elements 18, 20, no mechanical load is placed on the contact area 34, 36, that is, the contacting portions 22, 24 lie in the circuit board connectors 34, 36 under low or even no stress at all. Furthermore, the compensating loops 21, 23 serve for temperature equalization. The compensating loops in this case serve for relieving the stress on the circuit board connectors 34, 36 in the case of large changes in temperature.

The contacting portions 22, 24, which can be described as being H-shaped, enclose the circuit board 30 with the webs 25a and 25b, and thus provide an additional stabilization of the contact area. Thus, the retaining webs 25a, 25b serve for stabilization and retention of the contacting portions 22, 24 on the contact area 34, 36. Moreover, the retaining webs 25a, 25b serve for stabilizing the position of the circuit board 30 in the connection system 10.

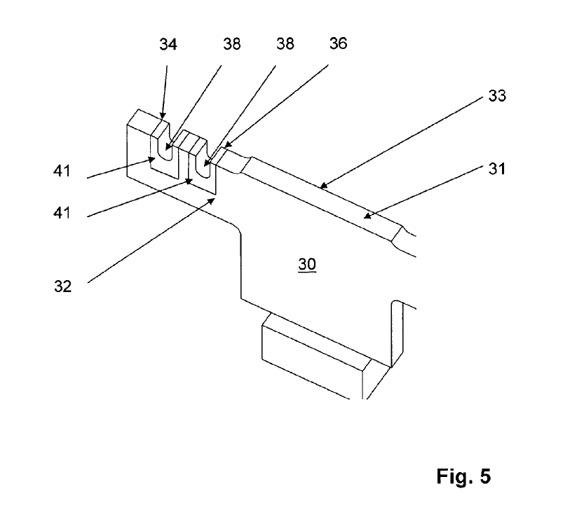

As is shown in FIG. 5, the circuit board is coated in an electrically conductive manner in the area of the recesses 38. Contact with the contact elements 18, 20 is thus established. A possible alternative is a copper lamination in the area of the recesses 38 on the circuit board 30. According to the invention, it is possible, moreover, to configure or coat the circuit board also to be metallically conductive on its front side 32 and the rear side 33 in the area of the recesses 38. The electrically conductive lamination 40 on the front side 32 of the circuit board 30 in this case extends substantially over the area of the circuit board covered by the retaining webs 25a, that is, the retaining webs 25a, as well as the retaining webs 25b, have a width corresponding to the contact surfaces 40.

In this case, it naturally is a matter of course that, if the contacting portions are to engage into the recesses 38 in a C-shape, only those areas are coated or configured to be electrically conductive in which the retaining webs 25a, 25b rest on the outer surface 32, 33 of the circuit board. It is also conceivable that only one of the sides 32, 33 of the circuit board 30 is configured or coated so as to be electrically conductive. Laminating the circuit board connectors 34, 36 beyond the area of the recesses 38 offers the advantage that a greater mechanical stress on the soldering area of the circuit board connectors 34, 36 is possible in the case of, for example, a soldered contacting between contact elements 18, 20 and the circuit board 30. Moreover, a secure contacting is also ensured, regardless of whether the electrical contact between the contact element 18, 20 and the circuit board 0 is realized by soldering, gluing or only by force fit or frictional fit. In this case, it must also be taken into account that temperature changes in the order of up to 200° C. must be ensured.

1. Electrical connection system, comprising
a housing into which electrical and/or mechanical components can be integrated;
at least one circuit board which can be positioned on the housing and comprises at least one circuit board connector; and
at least one contact element retained firmly on the housing, said contact element having on a free end a contacting portion for electrical contacting of the circuit board connector,
wherein the contact element is at least in some portions formed to be flexible, so that the contacting portion can be bent from an assembly position, in which the contact element is not in electrical contact with the circuit board connector, into a contacting position, in which the contact element is in electrical contact with the circuit board connector.

2. Electrical connection system according to claim 1, wherein the at least one contact element is embedded into the housing.

3. Electrical connection system according to claim 1, wherein the housing has an opening into which the circuit board can at least partially be inserted from the outside.

4. Electrical connection system according to claim 3, wherein the opening in the bottom of the housing is configured as a pocket.

5. Electrical connection system according to claim 1, wherein the at least one circuit board connector forms a recess open towards an end face of the circuit board.

6. Electrical connection system according to claim 5, wherein the contacting portion is substantially configured C-shaped or H-shaped, with two parallel retaining webs (25a, 25b) and a connecting web extending between them, wherein the connecting web (25c) is insertable into the recess.

7. Electrical connection system according to claim 6, wherein the retaining webs rest on the main surfaces of the circuit board when the connecting web is inserted into the recess.

8. Electrical connection system according to claim 7, wherein the contacting portion is retained in the contacting position by force and/or positive fit or frictional fit on the circuit board

9. Electrical connection system according to claim 1, wherein the contacting portion, in the contacting position, is soldered to the circuit board connector or glued using a conductive adhesive.

10. Electrical connection system according to claim 1, wherein the housing is produced from plastic or insulated light metal.

11. Electrical connection system according to claim 1, wherein the housing is an injection-molded article.

12. Electrical connection system according to claim 1, wherein a compensating loop is molded into the contact element in an area in front of the contacting portion.

13. Electrical connection system according to claim 12, wherein the compensating loop has an S-shape.
